(19) United States
(12) Patent Application Publication
(10) Pub. No.: US 2017/0210275 A1
(43) Pub. Date: Jul. 27, 2017

(54) PASSENGER COMPARTMENT ILLUMINATION DEVICE

(71) Applicant: KASAI KOGYO CO., LTD., Kanagawa (JP)

(72) Inventor: Kazuya KUBO, Yamato-shi, Kanagawa (JP)

(21) Appl. No.: 15/328,291

(22) PCT Filed: Apr. 17, 2015
(86) PCT No.: PCT/JP2015/061839

§ 371 Date: Jan. 23, 2017

(30) Foreign Application Priority Data
Aug. 22, 2014 (JP) 2014-168923

(51) Int. Cl. B60Q 1/00; B60R 13/02; B60Q 3/62; B60Q 3/54; F21V 8/00; B60Q 3/20

(52) U.S. Cl. CPC B60Q 1/0005; G02B 6/0013; B60Q 3/20; B60Q 3/62; B60Q 3/54; B60R 13/02; B60Q 2500/10

(57) ABSTRACT

A purpose of the present invention is to provide a passenger compartment illumination device capable of remarkably reducing transmission of an impact applied to a vehicle body panel to an interior trim. A passenger compartment illumination device to be attached to an interior trim on a side facing a vehicle body panel includes a light source, a light-guiding member that receives incident light from the light source as extending along the interior trim, and a case that houses the light source and the light-guiding member as being attached to the interior trim. The case includes a protruding portion arranged on a side face of the case on the side facing the vehicle body panel as protruding toward the vehicle body panel.

### CROSS-REFERENCE TO RELATED APPLICATIONS

This application is a National Stage Entry application of PCT International Application No. PCT/JP2015/061839, filed on Apr. 17, 2015, which claims the priority benefit of Japanese Patent Application No. 2014-168923, filed on Aug. 22, 2014, the entire contents of both of which are hereby incorporated by reference.

### BACKGROUND

1. Technical Field

The present invention relates to a passenger compartment illumination device and relates to a passenger compartment illumination device to be attached to an interior trim on a side facing a vehicle body panel.

2. Description of the Background

As illustrated in Japanese Patent Application Laid-open No. 2003-212038, there has been known a passenger compartment illumination device capable of illuminating a vicinity of an armrest of a door trim (interior trim), for example, through an opening of the door trim.

The passenger compartment illumination device includes a light-emitting element (light source), a light-guiding member that receives incident light from the light-emitting element as extending along the interior trim, and a case that houses the light-emitting element and the light-guiding member as being attached to the interior trim.

In this case, the passenger compartment illumination device attached to a back face of the interior trim narrows a gap against a vehicle body panel to be relatively small. When an impact is applied to the vehicle body panel, the vehicle body panel concaved thereby is contacted to the passenger compartment illumination device (case) and the impact is transmitted directly to the interior trim. Accordingly, the interior trim is apt to be deformed due to distortion.

### BRIEF SUMMARY

In view of the above, an object of the present invention is to provide a passenger compartment illumination device capable of remarkably reducing transmission of an impact applied to a vehicle body panel to an interior trim.

The present invention is to be recognized as follows.

(1) A first aspect of the present invention is a passenger compartment illumination device to be attached to an interior trim on a side facing a vehicle body panel, the passenger compartment illumination device comprising:
a light source;
a light-guiding member configured to receive incident light from the light source, the light-guiding member extending along the interior trim; and
a case that houses the light source and the light-guiding member, the case being attached to the interior trim, the case including a protruding portion arranged on a side face of the case on the side facing the vehicle body panel, the protruding portion protruding toward the vehicle body panel.

(2) In the configuration of (1), the protruding portion may be arranged on the side face of the case at a region where the light-guiding member is housed.

(3) In the configuration of (1), the protruding portion may be arranged on the side face of the case at a region where the light source is housed.

(4) In the configuration of (1), the protruding portion may include a first protruding portion arranged on the side face of the case at a region where the light-guiding member is housed and a second protruding portion arranged on the side face of the case at a region where the light source is housed, and the first protruding portion and the second protruding portion may be arranged separately.

(5) In any of the configurations of (1) to (4), the protruding portion may be formed into a box shape with an opening formed at the side face of the case.

(6) In any of the configurations of (1) to (3), the protruding portion may be formed into a rib shape.

According to the passenger compartment illumination device, it is possible to remarkably reduce transmission of an impact applied to the vehicle body panel to the interior trim.

### BRIEF DESCRIPTION OF DRAWINGS

FIG. 1 is a front view illustrating a door trim to which a passenger compartment illumination device of the present invention is attached.

FIG. 2 is a sectional view at line II-II in FIG. 1.

FIG. 3 is an exploded perspective view illustrating a first embodiment of the passenger compartment illumination device of the present invention.

FIG. 4 is a side view of a part of the passenger compartment illumination device of the present invention.

FIG. 5A is a sectional view at line V-V in FIG. 3.

FIG. 5B is a sectional view at line b-b in FIG. 5A.

FIG. 6A is a sectional view illustrating a second embodiment of the passenger compartment illumination device of the present invention, as corresponding to FIG. 5A.

FIG. 6B is a sectional view illustrating a modified example of the second embodiment of the passenger compartment illumination device of the present invention, as corresponding to FIG. 5A.

FIG. 7 is a sectional view illustrating a third embodiment of the passenger compartment illumination device of the present invention, as corresponding to FIG. 5A.

FIG. 8 is a sectional view illustrating a fourth embodiment of the passenger compartment illumination device of the present invention, as corresponding to FIG. 5A.

### DETAILED DESCRIPTION

In the following, description will be provided in detail on embodiments of the present invention with reference to the attached drawings. Here, the same sign is given to the same element throughout the description of the embodiments.

### First Embodiment

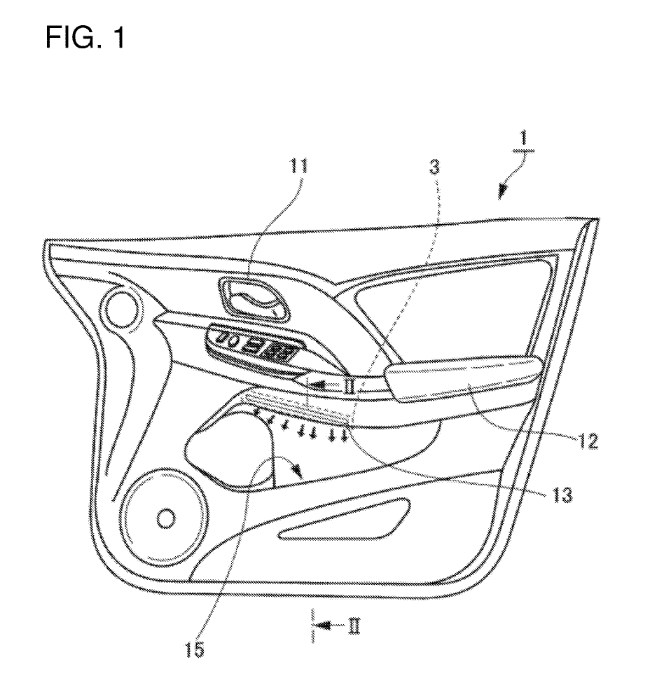

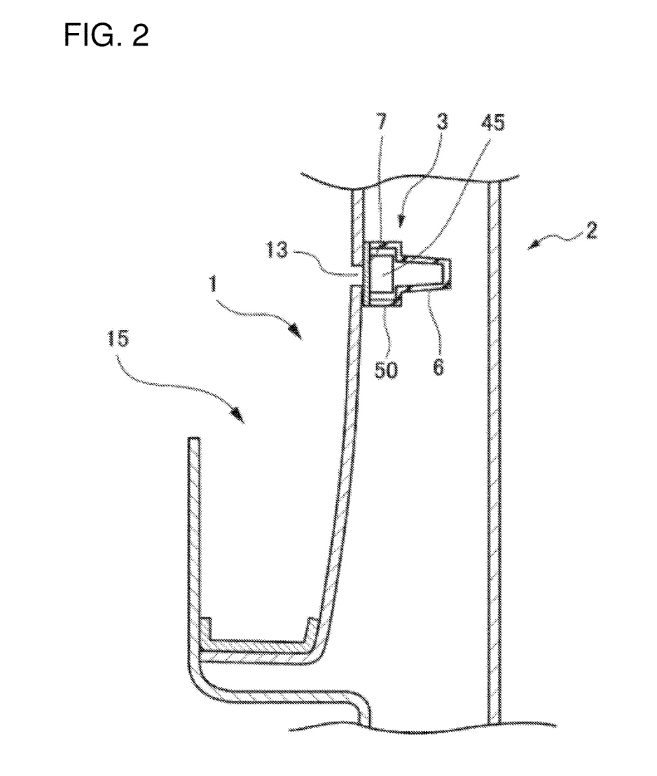

FIG. 1 is a front view illustrating a door trim to which a passenger compartment illumination device of the present invention is attached. In FIG. 1, a door trim (interior trim) 1 is arranged at a vehicle body panel 2 (see FIG. 2) on the passenger compartment side. An inside handle 11 capable of being operated by a driver or a passenger is attached to the door trim 1 and an armrest 12 extending in a travel direction of a vehicle is arranged below the inside handle 11. Further, a door pocket 15 is arranged below the armrest 12. An elongated opening 13 is arranged at the door trim 1, for example, along the extending direction of the armrest 12 between the armrest 12 and the door pocket 15. A passenger compartment illumination device (hereinafter, simply called an illumination device) 3 is attached onto a back face of the door trim 1 at the opening 13. The vicinity of the door pocket 15 is irradiated with light from the illumination device 3 through the opening 13.

FIG. 2 is a sectional view at line II-II in FIG. 1. As illustrated in FIG. 2, the illumination device 3 is attached onto a face of the door trim 1 on the vehicle body panel 2 side. Thus, the illumination device 3 is arranged between the door trim 1 and the vehicle body panel 2.

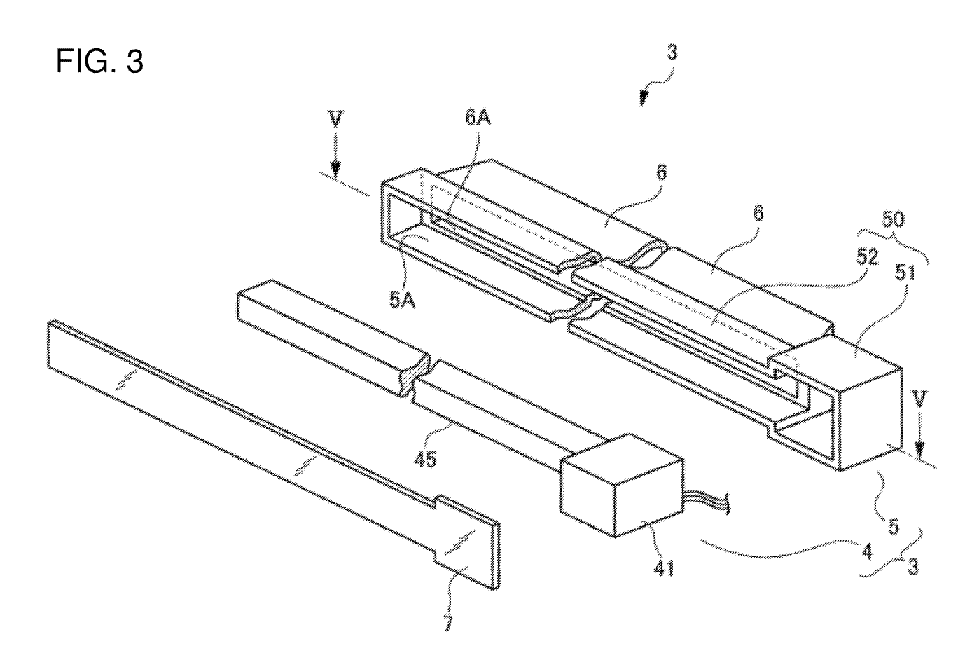

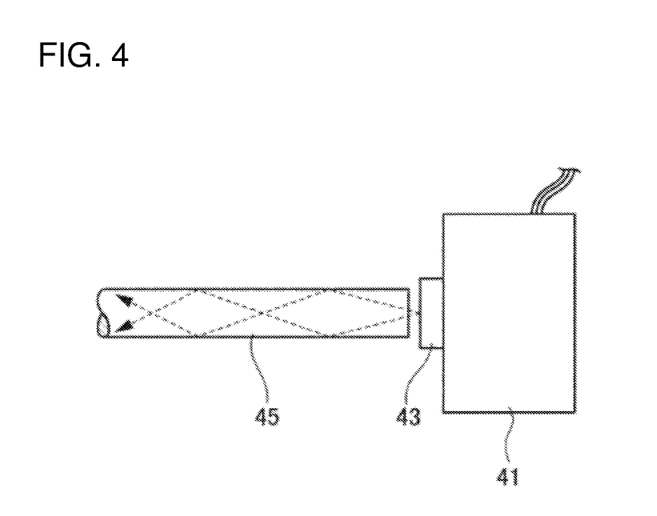

FIG. 3 is an exploded perspective view of the illumination device 3. The illumination device 3 illustrated in FIG. 3 includes a light source portion 4, a case portion 5, and a translucent plate 7, which are illustrated in an exploded state. The light source portion 4 includes a power source 41, a light-emitting element (light source) 43 (see FIG. 4) caused to illuminate by the power source 41, and a light-guiding member 45 that guides light from the light-emitting element 43. FIG. 4 illustrates a state that the light-emitting element 43 is mounted on a side face of the power source 41 and light from the light-emitting element 43 is transmitted within the light-guiding member 45 after entering through an end face of the light-guiding member 45. The light-guiding member 45 emits light of the light-emitting element 43 through a face thereof to serve as a linearly-shaped light source. The light-guiding member 45 has a rectangular cross-section, for example. In FIG. 4, the light-guiding member 45 is illustrated as being linearly shaped. However, not limited thereto, it is naturally possible as well that the light-guiding member 45 is shaped as being curved in accordance with usage and the like of the illumination device 3.

Further, the case portion 5 includes a case 50 being a box body capable of housing the light source portion 4 through an opening 5A. The case 50 includes a first case 51 that houses the power source 41, and a second case 52 that houses the light-emitting element 43 and the light-guiding member 45. The first case 51 and the second case 52 have enough width and depth to house the power source 41, and the light-emitting element 43 and the light-guiding member 45, respectively, so that the power source 41, the light-emitting element 43, and the light-guiding member 45 can be attached (fixed) to the case 50.

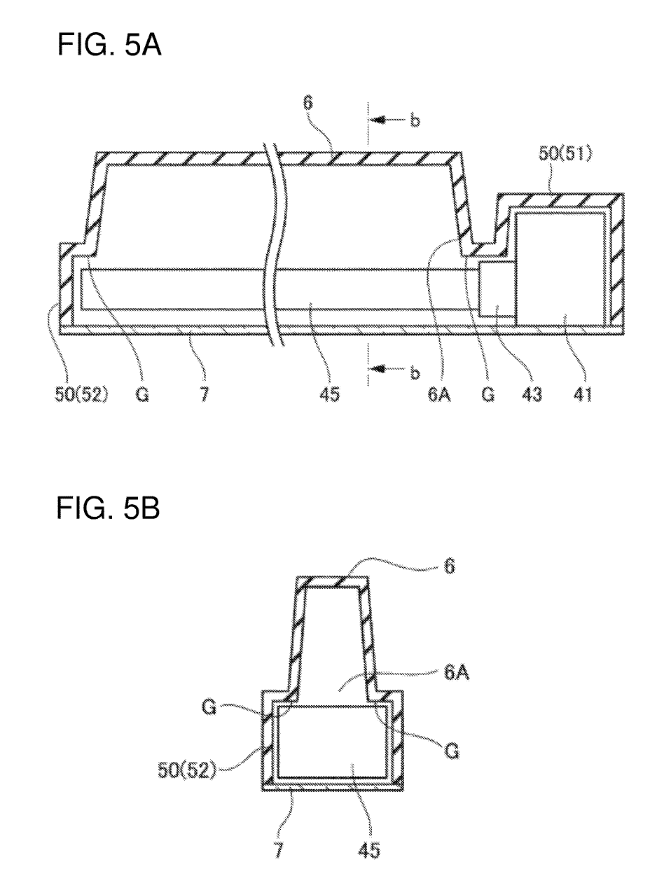

Further, a protruding portion 6 is arranged, for example, on a bottom face of the second case 52 at a region where the light-guiding member 45 is housed (corresponding to a side face thereof on the vehicle body panel 2 side when the illumination device 3 is attached to the door trim 1). As illustrated in FIG. 5A being a sectional view at line V-V in FIG. 3 and FIG. 5B being a sectional view at line b-b in FIG. 5A, the protruding portion 6 is formed into a box shape as having, at the bottom face of the second case 52, an opening 6A whose area is slightly smaller than area of the bottom face of the second case 52. Thus, a step G is formed at a boundary between the second case 52 and the protruding portion 6. According to the step G, the light-guiding member 45 is housed in place by the second case 52.

Further, the translucent plate 7 is arranged so as to close the opening 5A of the case portion 5 by which the light source portion 4 is housed. Outside of the illumination device 3 is to be irradiated with light from the light source portion 4 through the translucent plate 7.

As illustrated in FIG. 2, the illumination device 3 structured as described above is attached to the door trim 1 so that the translucent plate 7 (see FIG. 3) faces to the opening 13 of the door trim 1 (see FIG. 1). Accordingly, the protruding portion 6 is arranged to protrude toward the vehicle body panel 2. The protruding portion 6 arranged as described above serves as an impact absorbing member.

When an impact is applied to the vehicle body panel 2, the vehicle body panel 2 concaved thereby is contacted to the protruding portion 6 of the illumination device 3. Accordingly, buckling is apt to occur at the protruding portion 6 and deformation thereby can cause the impact from the vehicle body panel 2 to be absorbed. Thus, it is possible to suppress transmission of a large impact to the door trim 1.

In FIG. 3, the attaching region of the case portion 5 to the door trim 1 is provided with the translucent plate 7. However, not limited thereto, it is also possible that an opening is simply formed thereat without having the translucent plate 7. In this case, the opening 13 of the door trim 1 may be closed by a translucent plate.

Further, as illustrated in FIG. 3, the light-guiding member 45 has a rectangular cross-section. However, not limited thereto, it is naturally possible that the cross-section has a circular shape or another shape.

### Second Embodiment

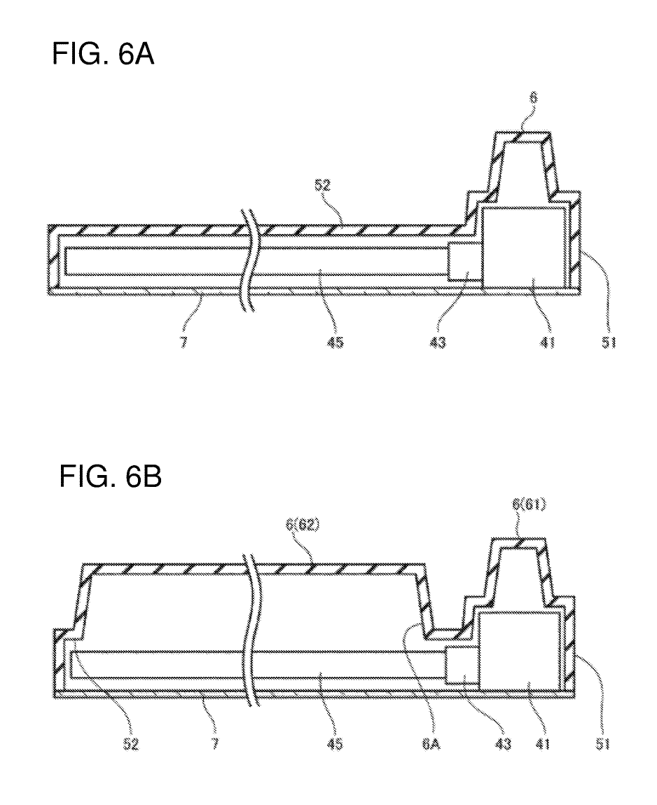

In the first embodiment, the protruding portion 6 arranged at the case 50 of the illumination device 3 is arranged on the bottom face (side face) of the second case at the region where the light-guiding member 45 is housed. However, not limited thereto, the protruding portion 6 may be arranged on a bottom face (side face) of the first case at a region where the power source 41 is housed as illustrated in FIG. 6A. In this case, the similar effects can be obtained as well. Further, as illustrated in FIG. 6B, it is naturally possible that the protruding portion 6 is arranged on the bottom face (side face) of each of the first case 51 and the second case 52. Here, a first protruding portion 61 being the protruding portion 6 arranged at the first case 51 and a second protruding portion 62 being the protruding portion 6 arranged at the second case 52 may be arranged as being separated from each other. Accordingly, the light source portion 4 can be attached to the case 50 with a simple structure.

### Third Embodiment

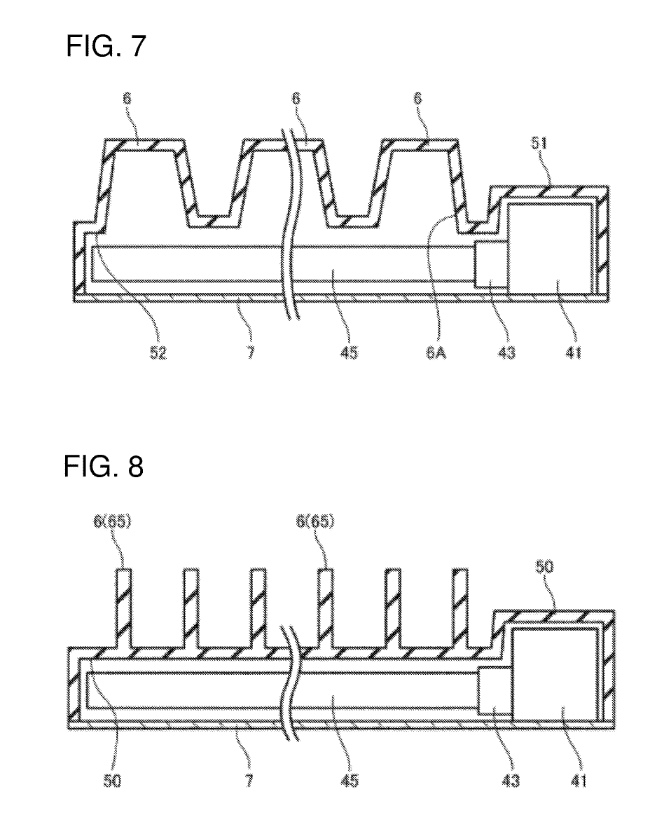

In the above embodiments, the protruding portion 6 arranged at the second case 52 of the illumination device 3 is singularly arranged along the longitudinal direction of the second case 52. However, as illustrated in FIG. 7, it is also possible to be arranged as being divided into plural pieces. In this case, the similar effects can be obtained as well.

### Fourth Embodiment

In the abovementioned embodiments, the protruding portion 6 arranged at the case 50 is formed into a box shape as having the opening 6A (see FIG. 6B) at the bottom face of the case 50. However, not limited thereto, the protruding portion 6 may be arranged as a plurality of ribs 65 arranged side by side along the longitudinal direction of the case 50, as illustrated in FIG. 8. That is, the protruding portion 6 may be formed into a rib shape. In this case, the similar effects can be obtained as well.

Although the present invention is described using the embodiments in the above, it is obvious that the technical scope of the present invention is not limited to the description of the abovementioned embodiments. It is obvious that that a variety of modifications and improvements can be applied to the abovementioned embodiments. According to description of claims, it is obvious that embodiments to which such modifications and improvements are applied are included in the technical scope of the present invention.

### REFERENCE SIGNS LIST

1 Door trim

11 Inside handle

12 Armrest

13 Opening

15 Door pocket

2 Vehicle body panel

3 Passenger compartment illumination device (illumination device)

4 Light source portion

41 Power source

43 Light-emitting element

45 Light-guiding member

5 Case portion

5A Opening

50 Case

51 First case

52 Second case

6 Protruding portion

61 First protruding portion

62 Second protruding portion

65 Rib

7 Translucent plate

1. A passenger compartment illumination device to be attached to an interior trim on a side facing a vehicle body panel, the passenger compartment illumination device comprising:
a light source;
a light-guiding member configured to receive incident light from the light source, the light-guiding member extending along the interior trim; and
a case that houses the light source and the light-guiding member, the case being attached to the interior trim, the case including a protruding portion arranged on a side face of the case on the side facing the vehicle body panel, the protruding portion protruding toward the vehicle body panel.

2. The passenger compartment illumination device according to claim 1, wherein the protruding portion is arranged on the side face of the case at a region where the light-guiding member is housed.

3. The passenger compartment illumination device according to claim 1, wherein the protruding portion is arranged on the side face of the case at a region where the light source is housed.

4. The passenger compartment illumination device according to claim 1,
wherein the protruding portion includes a first protruding portion arranged on the side face of the case at a region where the light-guiding member is housed and a second protruding portion arranged on the side face of the case at a region where the light source is housed, and
the first protruding portion and the second protruding portion are arranged separately.

5. The passenger compartment illumination device according to claim 1, wherein the protruding portion is formed into a box shape with an opening formed at the side face of the case.

6. The passenger compartment illumination device according to claim 2, wherein the protruding portion is formed into a box shape with an opening formed at the side face of the case.

7. The passenger compartment illumination device according to claim 3, wherein the protruding portion is formed into a box shape with an opening formed at the side face of the case.

8. The passenger compartment illumination device according to claim 4, wherein the protruding portion is formed into a box shape with an opening formed at the side face of the case.

9. The passenger compartment illumination device according to claim 1, wherein the protruding portion is formed into a rib shape.

10. The passenger compartment illumination device according to claim 2, wherein the protruding portion is formed into a rib shape.

11. The passenger compartment illumination device according to claim 3, wherein the protruding portion is formed into a rib shape.
